(19) United States
(12) Patent Application Publication
(10) Pub. No.: US 2008/0313593 A1
(43) Pub. Date: Dec. 18, 2008

(54) Occupancy Based on Pattern Generation Method For Maskless Lithography

(76) Inventors: Man Seung Seo, Busan (KR); Haeryung Kim, Yongin-si (KR)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 12/095,037

(22) PCT Filed: Nov. 2, 2006
(86) PCT No.: PCT/KR06/04540

§ 371 Date: May 27, 2008

(30) Foreign Application Priority Data
Nov. 28, 2005 (KR) 10-2005-0114003

(51) Int. Cl. G06F 17/50

(52) U.S. Cl. 716/21

(57) ABSTRACT

An occupancy based pattern generation method for a maskless lithography system using micromirrors is disclosed. The present invention includes the steps of recognizing a pattern upon the substrate through the extraction of the pattern boundary and the construction of the pattern region and recognizing the pattern upon the micromirror through the confirmation of the micromirror dependent lithographic pattern region, the extraction of the micromirror dependent pattern based on the occupancy, and the construction of the stream of binary patterns containing binary reflection information for the micromirrors in accordance with the substrate scrolling.

### TECHNICAL FIELD

The present invention relates to an occupancy based pattern generation method for a maskless lithography system using micromirrors, and more particularly, to an occupancy based pattern generation method useful for a maskless lithography system (and other systems) that generates a pattern on a large-scale substrate (e.g., a flat panel display (FDP) currently fabricated in Korea) using micromirrors.

### BACKGROUND ART

Currently, lithography systems using masks are widely used by display manufacturers. In the lithography system, since a quality of exposed pattern depends on precisions of a mask and an original mask for fabricating the former mask, the precise fabrication of the masks needs considerable time and expense. And, the problems caused by masks such as contamination by masks, disposal of masks, and alignment of masks are reported in the FPD fields. Moreover, in the lithography system, an original mask and masks have to be fabricated again each time a pattern is changed.

To solve those problems, many efforts have been made to research, design and develop a lithography system without a mask. The maskless lithography system can be classified into a system using a laser beam, a system using an inkjet, a system using an electron beam and the like. In case of the laser beam system, it takes a considerable time to generate a pattern. In case of the inkjet system, a nozzle is choked frequently. Since the lithography using an electron beam needs a workspace such as a vacuum chamber and the like, many limitations are put on the lithography using an electron beam.

Recently, spatial light modulator (SLM) devices for micro-electro-mechanical system (MEMS) based digital light processing such as the digital micromirror device (DMD) by Texas Instruments Inc. and some other SLMs have brought innovation to the field of microdisplays. In a maskless lithography system using micromirrors, a micromirror array plays a role as a virtual mask to enable a pattern to be exposed on a substrate at high speed with less cost. Compared to other maskless lithography technologies, a lithography system using micromirrors is capable of handling various patterns quickly and has many advantages including sufficient throughput, precise and high resolution, excellent lithography quality, efficiency in time and expense, etc.

The lithography using the micromirrors is able to achieve excellent results by processing various patterns in short time but has difficulty in its operation.

In order to generate lithographic patterns, all the micromirrors in a micromirror array need to be individually and instantly adjusted for reflections. Information on each reflection for millions of micromirrors should be determined and sent to a micromirror controller. Besides, like the lithography system using the micromirrors to implement the method of the present invention, it is more difficult to generate lithographic patterns on a scrolled substrate using a micromirror array in a state rotated at a small angle against a scrolled direction of the substrate.

Various lithographic pattern generating methods using micromirrors are patented or applied for patents at home and abroad. Most of the methods disclosed in Korean Patent Applications (No. 10-2004-0038111, No. 10-2004-0034806, No. 10-2004-0039213, No. 10-2004-0047343, No. 10-2004-0059541) by ASML in Nederland relate to methods of modulating light beam output through a light filter, light modulator, or micromirror reflection angle adjustment. Those methods are not appropriate for generating various patterns for the FPD, and limited to generation of typical patterns (e.g., semiconductor wafer pattern) mainly including lines rather than arcs.

Meanwhile, Ball Semiconductor Inc. has proposed various kinds of maskless lithographic pattern generation methods disclosed in T. Kanatake, “High Resolution point array”, U.S. Pat. No. 6,870,604, W. Mei, “Point array maskless Lithography”, U.S. Pat. No. 6,473,237, W. Mei, T. Kanatake, and A. Ishikawa, “Moving exposure system and method for maskless lithography system”, U.S. Pat. No. 6,379,867, etc. Yet, the methods proposed by Ball Semiconductor Inc. show better results through a manipulation of a shape of a reflected light beam rather than keeping an original shape of a mirror pixel. So, a re-focusing of a light beam in such a different shape as a circular shape (point/dot) and a hexagonal shape is mandatory. In case of using a circular (point/dot) light beam, rotational angles of micromirrors are limited to discrete angles. So, those methods need additional optic devices for grating and have to use pre-determined discrete angles. And, their application fields are limited to small-sized pattern generation (e.g., printed circuit board pattern).

Recently, due to the rapid growth of FPD market, a size of an FPD panel is increased over 2 m×2 m and a pattern structure used for FPD lithography becomes very complicated and diversified. In fabrication of the FPD, it is expected that the above-explained related art methods are not feasible to generate FPD lithographic pattern without modulating an intrinsic rectangular light beam reflecting from a micromirror. The difficulties in generating FPD lithographic patterns using the related art methods, with the reflected light beam in its original shape and without adjustments on gray imaging levels are expected. The related art methods were developed to be focused on the lithographic paths of the reflected beam spots. Because of their familiarity with lithography using masks, the reflected beam was their primary concern instead of the pattern. Most of the existing criteria for micromirror reflection in the related art methods have been developed based on the assessment of lithographic paths of the reflected beam spots. Lithographic pattern generation was performed based on predetermined exposed spaces with specified reflections. It is uncertain if the related art methods will suffice when an unusual pattern appears. Thus, the related art methods are neither robust nor flexible for FPD lithography.

### DISCLOSURE OF INVENTION

Accordingly, the present invention is directed to an occupancy based pattern generation method for maskless lithography that substantially obviates one or more of the problems due to limitations and disadvantages of the related art.

An object of the present invention is to provide an occupancy based pattern generation method for maskless lithography, by which a pattern can be correctly, precisely and quickly generated on a substrate as an exposed object without a manipulation of an intrinsic form of a reflected light beam, without adjustment of a micromirror reflecting angle, without a restriction to rotational angles of micromirrors, without a restriction to a scrolling distance of a substrate per unit scrolling phase, in case that a pattern has a large size and diverse and complicated configuration.

Another object of the present invention is to provide an occupancy based pattern generation method for maskless lithography having a micromirror reflection criterion using the ratio of an area occupied by a pattern per unit mirror, i.e., an occupancy, which is robust and flexible regardless of a shape of reflected light beam, rotational angles of micromirrors, a scrolling distance of a substrate per unit scrolling phase, a size of pattern, and a structure or configuration of pattern.

To achieve these and other advantages in accordance with the purpose of the present invention, an occupancy based pattern generation method for a lithography system using micromirrors according to the present invention includes the steps of recognizing and generating a pattern upon the substrate through the extraction of the pattern boundary and the construction of the pattern region and recognizing and generating the pattern upon the micromirror through the confirmation of the micromirror dependent lithographic pattern region, the extraction of the micromirror dependent pattern based on the occupancy, and the construction of the stream of binary patterns containing binary reflection information for the micromirrors in accordance with the substrate scrolling.

Preferably, the method further includes the step of loading CAD data into a memory through parsing of the CAD data prior to extracting the boundary of the pattern.

Preferably, the method further includes the step of transmitting the accumulated binary pattern data to a micromirror controller.

Preferably, the extraction of the pattern boundary is carried out by reconstructing a geometric entity having an open loop into the one with a closed loop.

Preferably, the construction of the pattern region is carried out by an execution of set operations on polygons upon computational geometry.

Preferably, the confirmation of the micromirror dependent lithographic pattern region is carried out by projecting a pattern onto micromirrors in accordance with the micromirror rotation and the substrate misalignment.

Preferably, the extraction of the micromirror dependent pattern based on the occupancy is carried out by comparing the occupied area of the pattern per unit micromirror to the user specified occupancy limit to determine the binary reflection based upon the occupancy and by converting the result of binary reflection into binary data as the micromirror dependent pattern.

Preferably, the construction of the stream of binary patterns containing binary reflection information for the micromirrors is carried out by accumulating the binary reflection information contained in the micromirror dependent pattern at every substrate location in the sequence of substrate scrolling.

Preferably, the confirmation of the micromirror dependent lithographic pattern region is carried out by projecting the pattern onto micromirror array in a manner of rotating the pattern at an angle opposite to a rotational angle of the micromirror array and rotating the extracted part of the pattern back to an original position.

### BRIEF DESCRIPTION OF THE DRAWINGS

FIG. 1 is a schematic diagram of a maskless lithography system to implement a method according to the present invention;

FIG. 2 is a flowchart of an occupancy based pattern generation method according to the present invention;

FIG. 3(a)-(f) is a schematic diagram to explain an occupancy based pattern generation method according to the present invention;

FIG. 4 is a diagram for occupancy, exposure intensity and pattern thickness according to the present invention;

FIG. 5 is a graph for correlation between occupancy, exposure intensity and pattern thickness according to the present invention;

FIG. 6A and FIG. 6B are graphs of accumulated exposure intensity represented as a function of line width and occupancy according to the present invention;

FIG. 7A and FIG. 7B are graphs of accumulated exposure intensity represented as a function of line width upon substrate scrolling according to the present invention;

FIG. 8A and FIG. 8B are graphs of accumulated exposure intensity represented as a function of occupancy upon substrate scrolling according to the present invention;

FIGS. 9A to 9C are graphs of accumulated exposure intensity represented as a function of line width and occupancy upon beam scratch for substrate scrolling according to the present invention;

FIG. 10A is a diagram of a boundary extracted from a test pattern according to the present invention;

FIG. 10B is a diagram of a result of exposure simulation by accumulating binary data according to the present invention;

FIG. 11 is a diagram of a main window of an occupancy based pattern generation system to implement the present invention;

FIGS. 12(a) to 12(d) show electron microscope images of patterns on actual wafers, which are generated by the occupancy based pattern generation system according to the present invention, exposed, and developed; and

FIG. 13(a) and FIG. 13(b) show electron microscope images of patterns on FPD panels, which are generated by the occupancy based pattern generation system according to the present invention, exposed, and developed.

### BEST MODE FOR CARRYING OUT THE INVENTION

The aforesaid objectives, features and advantages of the invention will be set forth in the description which follows, and in part will be apparent from the description. Reference will now be made in detail to one preferred embodiment of the present invention, examples of which are illustrated in the accompanying drawings.

In the following description, specific configurations, arrangements and conditions of a lithography process using micromirrors are explained, which are just exemplary. And, other configurations, arrangements and conditions can be used without departing from the scope of the present invention.

First of all, a maskless lithography device using micromirrors to implement a maskless lithographic pattern generation method according to the present invention is explained. In this case, it is apparent that the explanation of the maskless lithography device using the micromirrors is proposed for the purpose of the explanation of the implementation of the present invention but has nothing to do with the present invention.

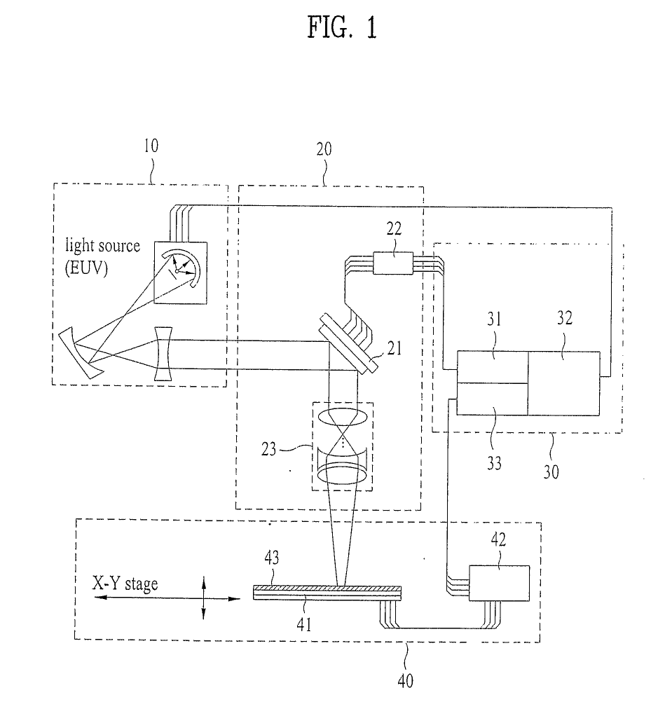

FIG. 1 is a schematic diagram of a maskless lithography system to implement a method according to the present invention.

Referring to FIG. 1, a maskless lithography system using micromirrors mainly includes four parts.

In particular, the maskless lithography system includes a radiating device 10 radiating a light source such as EUV (extreme ultraviolet) and the like, an exposure device 20 reflecting a light beam irradiated from the radiating device 10 onto a substrate selectively to form a pattern, a pattern control device 30 controlling a pattern generation of the exposure device 20, and an X-Y stage device 40 scrolling the substrate in an X-Y plane.

The exposure device 20 includes a micromirror array 21, a micromirror controller 22 and focusing optics 23.

The micromirror array includes 786,412 micromirrors (horizontal 1024/vertical 768) and reflects the light beam received from the radiating device 10 onto the substrate via the focusing optics 23 according to a reflection control signal of the micromirror controller 22.

The micromirror controller 22 supplies reflection control signals to the micromirror array 21 to enable a prescribed pattern to be generated through on or off reflection.

The focusing optics 23 reduces or enlarges the reflected beam from the micromirror array 21 conserving a shape of the beam and then irradiates the reduced or enlarged beam onto a prescribed area of the substrate 43 on which a photoresist layer is coated thereon.

The pattern control device 30 includes a pattern generation unit 31 supplying a reflection control signal for pattern generation to the micromirror controller 22, a radiating source control unit 32 controlling an output of the radiating source device 10 and a stage control unit 33 providing a control signal for a scrolling of an X-Y stage 41 to the stage controller 42 of the stage device 40.

The X-Y stage device 40 includes the X-Y stage 41 to which the photoresist layer coated substrate 43 is fixed and a stage controller 42 scrolling the X-Y stage 41 in the X-Y plane according to a control signal received from the stage controller 33.

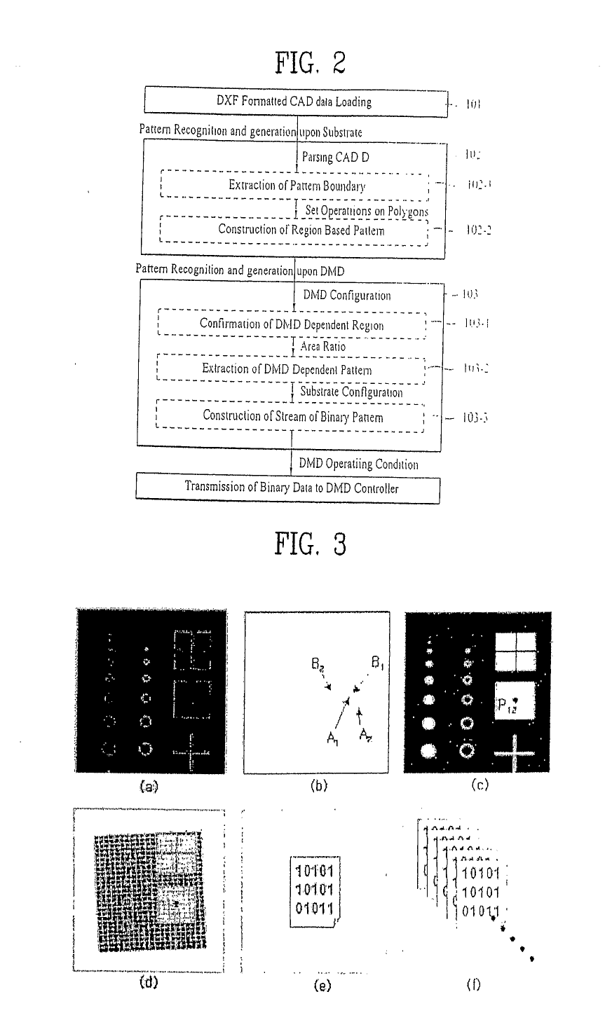

For the pattern generation method in lithography using the above-configured or similarly-configured micromirror-using maskless lithography system, to facilitate the understanding of the occupancy based pattern generation method of the present invention, FIG. 3(a) to FIG. 3(f) showing the occupancy based pattern generation method according to the present invention are referred to according to the sequence of the flow of the occupancy based pattern generation method shown in FIG. 2 as a representative diagram of the present invention. A occupancy based pattern generation method for a maskless lithography system according to the present invention includes a step 101 of loading CAD data in a memory, a step 102 of generating a pattern by recognizing the pattern upon the substrate, a step 103 of generating a pattern by recognizing the pattern upon the micromirrors, and a step 104 of transmitting generated binary pattern data to a micromirror controller. And, the step 102 of generating the pattern by recognizing a pattern upon the substrate sequentially includes a step 102-1 of extracting a boundary of a pattern by CAD data parsing and a step 102-2 of constructing the pattern region by set operation on polygons. And, the step 103 of generating the pattern by recognizing the pattern upon the micromirrors sequentially includes a step 103-1 of confirming the micromirror dependent lithographic pattern region, a step 103-2 of extracting the micromirror dependent pattern based on the occupancy, and a step 103-3 of constructing the stream of binary patterns containing binary reflection information for the micromirrors in the sequence of substrate scrolling.

In the step 101 shown in FIG. 2, the occupancy based pattern generation method according to the present invention begins with loading the CAD (computer aided design) data written in DXF (drawing exchange format) or other format into the memory. In this case, an example of the inputted CAD data is shown in (a) of FIG. 3. In the CAD data used as an example, a diameter of circle is 50 μm˜700 μm and the space between two circles forming an annulation is 30 μm˜200 μm.

Subsequently, in the step 102 shown in FIG. 2, the step of recognizing and generating the pattern upon the substrate is carried out.

In the step 102-1 of extracting the boundary of the pattern by the CAD data parsing, geometric entities are considered as lines, arcs, and circles, and the boundary of the pattern is extracted by the conversion of geometric entities having disconnections into polygonal entities in the form of closed loops through chaining of each with the other. In this case, examples of boundaries of the patterns extracted from the CAD data by the present invention is shown in (b) of FIG. 3.

Subsequently, the step 102-2 of constructing the pattern region by set operations on polygons is executed. Referring to (b) of FIG. 3, polygons A₁ and A₂ are extracted from boundaries B₁ and B₂ of pattern. Referring to (c) of FIG. 3, overlapping polygons (e.g., A₁ and A₂) are converted to a pattern with a valid interior region P₁₂ by the set operation upon computational geometry. The set operation for the specific polygons shown in (b) and (c) of FIG. 3 can be represented by Formula 1.

P₁₂=(A₁−B₁)+(A₂−B₂)−2(A₁−B₁)∩(A₂−B₂)+B₁+B₂ [Formula 1]
In this case, a polygon A₁ is {r,φ|r≦R₁, 0≦C≦2π},
a polygon A₂ is {r,φr≦R₂/cos(0.5ηπ−φ), 0≦φ≦2π, η=(int)[(45−180φ/π)/90]},
a boundary B₁ is {r,φ|r=R₁, 0≦φ≦2π},
and a boundary B₂ is {r,φ|r=R₂/cos(0.5ηπ−φ), 0≦φ≦2π, η=(int)[(45−180φ/π)/90]}.

In this case, R₁ is the radius of the circle A₁ and A₂ is the radius of the inner circle which fits in the square A₂.

Subsequently, in the step 103 shown in FIG. 2, the step of recognizing and generating the pattern upon the micromirrors is carried out.

In the step 103-1 of confirming the micromirror dependent lithographic pattern region, a coordinate transformation relevant to micromirror rotation and substrate misalignment is carried out and the micromirror dependent region is confirmed by projecting a pattern onto micromirrors. In the lithography using the micromirrors, the micromirror array is rotated counterclockwise at a small angle θ relative to the longitudinal axis that is assigned as the substrate scrolling direction. In the present invention, the pattern region is considered as being rotated clockwise at the angle θ from the longitudinal axis, to account for the counterclockwise rotation of the micromirror frame and the coordinate transformation relevant to micromirror rotation and substrate misalignment, as shown in Formula 2, is then carried out to project the pattern onto micromirrors. The part of the region mapped onto the micromirror array, as shown in (d) of FIG. 3, is extracted and by rotating the extracted part of the pattern region counterclockwise back to its original position, the region is confirmed as the lithographic pattern region upon micromirror rotation at each scrolling step.

$$[ \begin{matrix}{z}_{1}^{*} \\ {z}_{2}^{*}\end{matrix} ] = [ \begin{matrix}cos {θ}^{*} & sin {θ}^{*} \\ - sin {θ}^{*} & cos {θ}^{*}\end{matrix} ] [ \begin{matrix}{z}_{1} \\ {z}_{2}\end{matrix} ] + [ \begin{matrix}- {z}_{10} cos {θ}^{*} & - {z}_{20} sin {θ}^{*} \\ {z}_{10} sin {θ}^{*} & - {z}_{20} cos {θ}^{*}\end{matrix} ] \qquad [ Formula 2 ]$$

In this case, z₁ and z₂ are reference coordinates upon the CAD data loading, z₁* and z₂* are floating coordinates relevant to the micromirror rotation and the substrate misalignment, (z₁₀, z₂₀) is reference coordinate of the floating origin relevant to micromirror rotation and substrate scrolling, and θ* is the floating angle which is the sum of the micromirror rotational angle and the substrate misalignment angle.

In the step 103-2 of extracting the micromirror dependent pattern based on the unique reflection criterion upon occupancy, which is working regardless of a shape of light beam, rotational angles of micromirrors, a scrolling step of substrate, a size of pattern or a structure or configuration of pattern, on or off reflection for each mirror is determined comparing the occupied area of the pattern per unit micromirror to the user specified area ratio and the result of on or off reflection is converted into binary data as the micromirror dependent pattern as shown in (e) of FIG. 3.

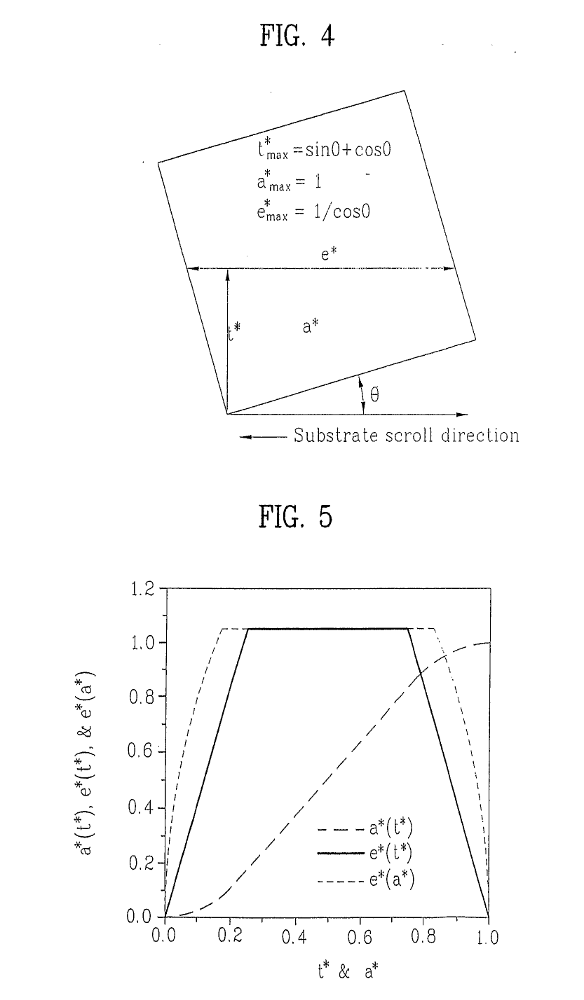

FIG. 4 is a diagram for an occupancy as dimensionless parameters (hereinafter abbreviated occupancy) a*=/FOV², exposure intensity as dimensionless parameters (hereinafter abbreviated exposure intensity) e*=e/FOV and pattern thickness as dimensionless parameters (hereinafter abbreviated pattern thickness) t*=t/FOV of the present invention. The occupancy a* is a function of the pattern thickness t* and is represented as Formula 3 to have the maximum of the area ratio equal to 1 at the maximum pattern thickness t_{MAX}*=sin θ+cos θ.

$${a}^{*} = ω ( 0 , {b}_{1} ) 0.5 ( tan θ + cot θ ) {t}^{* 2} + ω ( {b}_{1} , {b}_{2} ) ( tan θ + cot θ ) ( sin θ {t}^{*} - 0.5 sin {θ}^{2} ) + ω ( {b}_{2} , {b}_{3} ) [ 1 - 0.5 ( tan θ + cot θ ) {( sin θ + cos θ - {t}^{*} )}^{2} ] \qquad [ Formula 3 ]$$

And, the exposure intensity e* is a function of the pattern thickness t* and is then represented as Formula 4 to enable an integral of

$${\int }_{0}^{{t}_{MAX}^{*}} {e}^{*} d {t}^{*}$$

to have a value of 1.

$${e}^{*} = ω ( 0 , {b}_{1} ) 0.5 ( tan θ + cot θ ) {t}^{*} + ω ( {b}_{1} , {b}_{2} ) {( cos θ )}^{- 1} + ω ( {b}_{2} , {b}_{3} ) ( tan θ + cot θ ) {( sin θ + cos θ - t )}^{*} \qquad [ Formula 4 ]$$

Square wave function ω(bᵢ,bⱼ) in Formula 3 or Formula 4 is represented as Formula 5 using two unit step functions. And, step boundaries are b₁=sin θ, b₂=cos θ and b₃=sin θ+cos θ.

ω(bᵢ,bⱼ)=u(t*−bᵢ)−u(t*−bⱼ),(bᵢ<bⱼ) [Formula 5]

According to Formula 3 to Formula 5, the exposure intensity e* is a function of the occupancy a* to be represented as Formula 6. And, step boundaries are b₄=0.5 tan θ, b₅=1−0.5 tan θ and b₆=1.

$${e}^{*} = ω ( 0 , {b}_{4} ) \sqrt{2 ( tan θ + cot θ ) {a}^{*}} + ω ( {b}_{4} , {b}_{5} ) \sqrt{{( cos θ )}^{- 1}} + ω ( {b}_{5} , {b}_{6} ) \sqrt{2 ( tan θ + cot θ ) ( 1 - {a}^{*} )} \qquad [ Equation 6 ]$$

FIG. 5 is a graph for correlation between occupancy a* exposure intensity e* and pattern thickness t* obtained by Formula 3 to Formula 6. FIG. 5 shows that the reflection criterion upon the occupancy of the present invention is proper and reliable.

To verify the micromirror reflection criterion upon the occupancy of the present invention, accumulated exposure intensity simulations for the lithographic pattern generation by the micromirror array including (horizontal 90×vertical 120) mirrors are carried out. A pattern as a target for the simulations is a straight line configured in manner that a line width is 3.7947334 times of FOV (field of view, the size of a square light beam irradiated onto a substrate), that a center is located at ‘0’, and that a line boundary is located on +/−1.8973667FOV. A unit of the pattern is equal to the FOV. As simulation conditions, rotational angles 2.435°, 18.435° and 34.435° of mirror array and 501 occupancy limits (a_{c}*) between minimum 0 and maximum 1 are given.

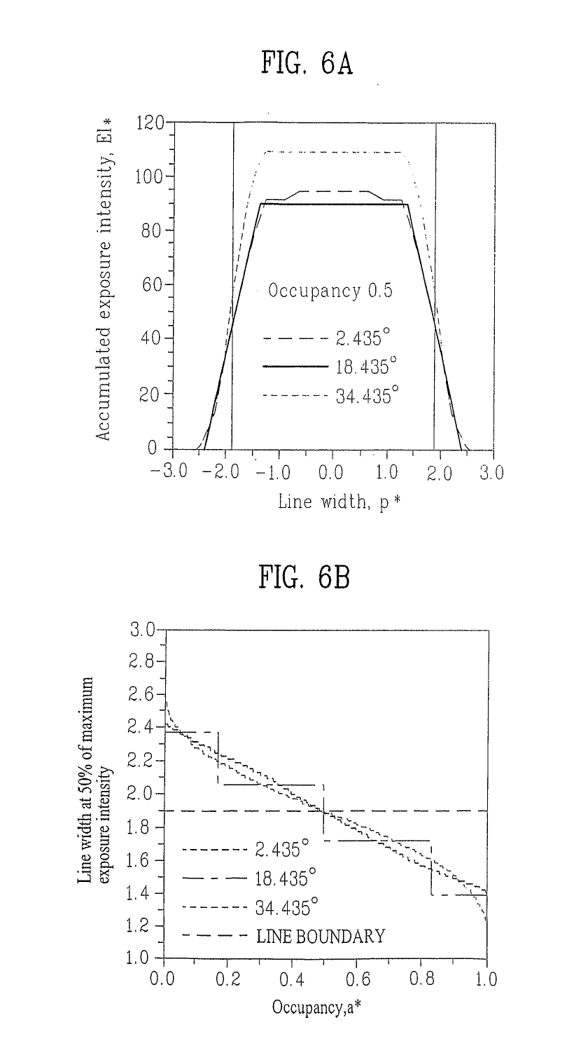

FIG. 6A is a graph of an accumulated exposure intensity EI* obtained by an occupancy limit a_{c}*=0.5 as a function of line width p*, from the simulations. Dimensionless line boundaries, which are obtained by dividing line boundaries by FOV and equal to +/−1.8973667, are shown as two vertical solid lines. Regardless of a rotational angle of a micromirror array, a line center is conserved and a line width p* is obtained at 50% of the=maximum exposure intensity EI*_{MAX}. FIG. 6B is a graph of a line width p*, which is obtained at 50% of the maximum exposure intensity EI*_{MAX=}as a function of an occupancy limit a_{c}*, from the simulations. Regardless of the micromirror rotational angle, the generated line width with 50% of the maximum exposure intensity EI*_{MAX} intersects the line boundary at the occupancy limit a_{c}* of 0.5. FIG. 6A and FIG. 6B insist that the occupancy limit a_{c}* should be prescribed to 0.5 in pattern generation in order to have the line width p* obtained at 50% of the maximum exposure intensity EI*_{MAX} equal to the actual line width. This will be explained more in detail by the simulation of accumulated exposure intensity EI* for the pattern generation upon substrate scrolling.

Meanwhile, the rotational angle 18.435° of the micromirror array in FIG. 6A or FIG. 6B is a discrete rotational angle that is essential for “High Resolution point array” (U.S. Pat. No. 6,870,604) or “Point array maskless Lithography” (U.S. Pat. No. 6,473,237) and is defined in K F, Chau, Z. Feng. R. Yang. A. lshikawa, “Moving resolution maskless Lithography”, Journal of Micro lithography, Microfabrication, and Micro systems, 2(4) 331-339, 2003. The step variation of the accumulated exposure intensity and line width at the discrete rotational angle shown in FIG. 6A and FIG. 6B may induce a doubt that a problem may occur in case of using the discrete rotational angle in generating a pattern by the pattern generation method of the present invention. Yet, as a matter of fact, the problem does not occur. This is because the line width and the line center are always conserved in the pattern generation method of the present invention, and we intentionally locate the line boundaries at vertices of the micromirrors for a straight line used as a pattern to analyze the effect of the discrete angle, which rarely happens in the case of a real pattern. Besides, the discrete angle can be converted easily to an analogue angle by changing the degree of rotation as small as 0.01% without resolution downgrade. In the pattern generation method of the present invention, since the light beam is maintained in the state of being on while a substrate is scrolling at each step, this analogue phenomenon (hereafter called beam scratch) should suppress the discrete effect. So, the pattern generation method according to the present invention is able to generate patterns without limitation put on the rotational angle of the micromirror array.

In order to confirm robustness and flexibility of the pattern generation method according to the present invention and to verify the effect of substrate scrolling steps, accumulated exposure intensity (EI*) simulations are carried out to generate a straight line, of which line boundary is located at +/−1.8973667FOV, on a substrate that is being scrolled, and using a micromirror array including (horizontal 80×vertical 80) mirrors. And, as simulation conditions, 0.43, 0.5 and 0.57 of three different dimensionless substrate scrolling steps (s*=s/FOV), 2.435° and 18.435° of a micromirror rotational angles and 101 occupancy limits (a_{c}*) between minimum 0 and maximum 1 are assigned.

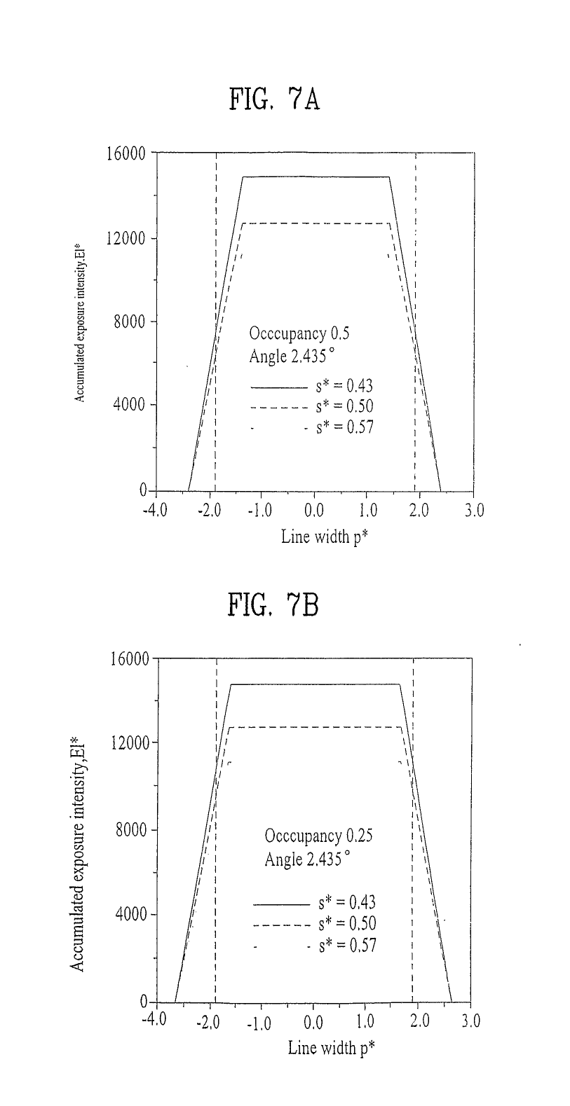

FIG. 7A is a graph of accumulated exposure intensity (EI*) obtained as a function of a line width (p*) with an occupancy limit a_{c}*=0.5, a mirror array rotational angle of 2.435° and a dimensionless substrate scrolling step s*=0.43, 0.5 or 0.57. FIG. 7B is a graph of accumulated exposure intensity (EI*) obtained as a function of a line width (p*) with an occupancy limit a_{c}=0.25, a mirror array rotational angle of 2.435° and a dimensionless substrate scrolling step s*=0.43, 0.5 or 0.57. At a specific occupancy limit (a_{c}*), regardless of a scrolling step (s*) of substrate, it shows that a line center is conserved and a line width is obtained at an expected ratio (50% if a_{c}*=0.5, 75% if a_{c}*=0.25) of the maximum exposure intensity (EI*_{MAX}).

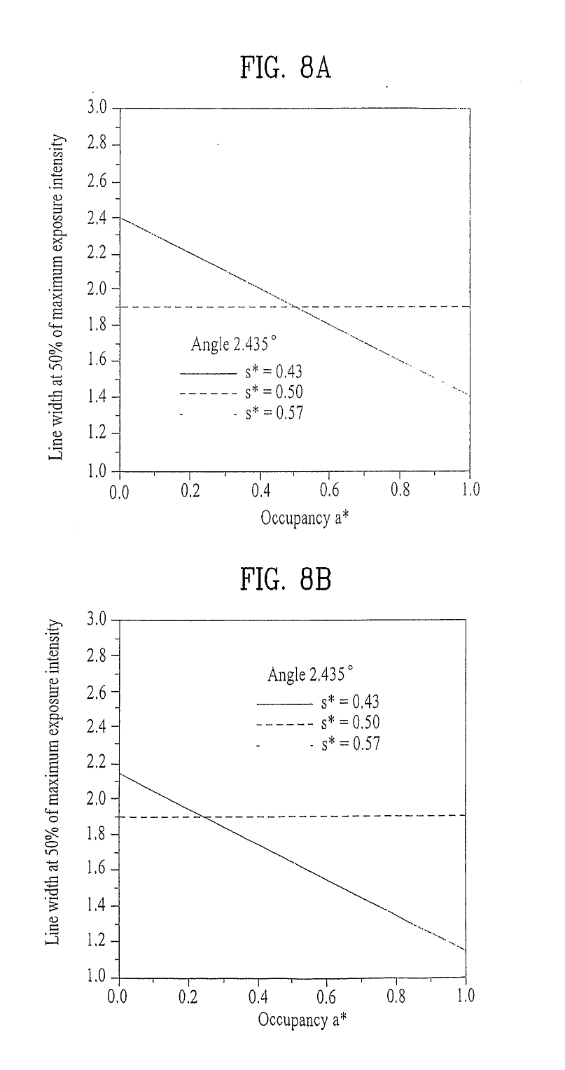

FIG. 8A is a graph of a line width (p*) obtained at 50% of maximum accumulated exposure intensity as a function of an occupancy limit (a_{c}*) at 0.43, 0.5 or 0.57 of dimensionless substrate scrolling step (s*) with 2.435° of mirror array rotational angle. FIG. 8B is a graph of a line width (p*) obtained at 75% of maximum accumulated exposure intensity as a function of an occupancy limit (a_{c}*) at 0.43, 0.5 or 0.57 of dimensionless substrate scrolling step (s*) with 2.435° of mirror array rotational angle. Regardless of a substrate scrolling step (s*), the generated line width with 50% of the maximum exposure intensity EI*_{MAX} intersects the line boundary at the occupancy limit a_{c}* of 0.5. And, the generated line width with 75% of the maximum exposure intensity EI*_{MAX} intersects the line boundary at the occupancy limit a_{c}* of 0.25. The simulation results shown in FIGS. 6A to 8B insist that the line width generated with an occupancy limit of X and obtained at (1−X)*100% of the maximum exposure intensity EI*_{MAX} will be equal to the actual line width, i.e., if the occupancy limit (a_{c}*) is prescribed to be X, the actual line width will be conserved at (1−X) % of the maximum exposure intensity, throughout the present invention. Therefore, the removal ratio of the photo resistant (PR) material through the developing process is 100X % with an occupancy limit (a_{c}*) of X in pattern generation, for the line width and center conservation through the method based on the occupancy limit of the present invention. In other words, any reasonable ratio of the PR can be removed to optimize the overall process if an identical value is assigned as the occupancy limit in pattern generation, with the present invention. Thus, the method based on the occupancy limit works free from the micromirror rotation angle, the substrate scrolling step, and the PR removal ratio, through the present invention.

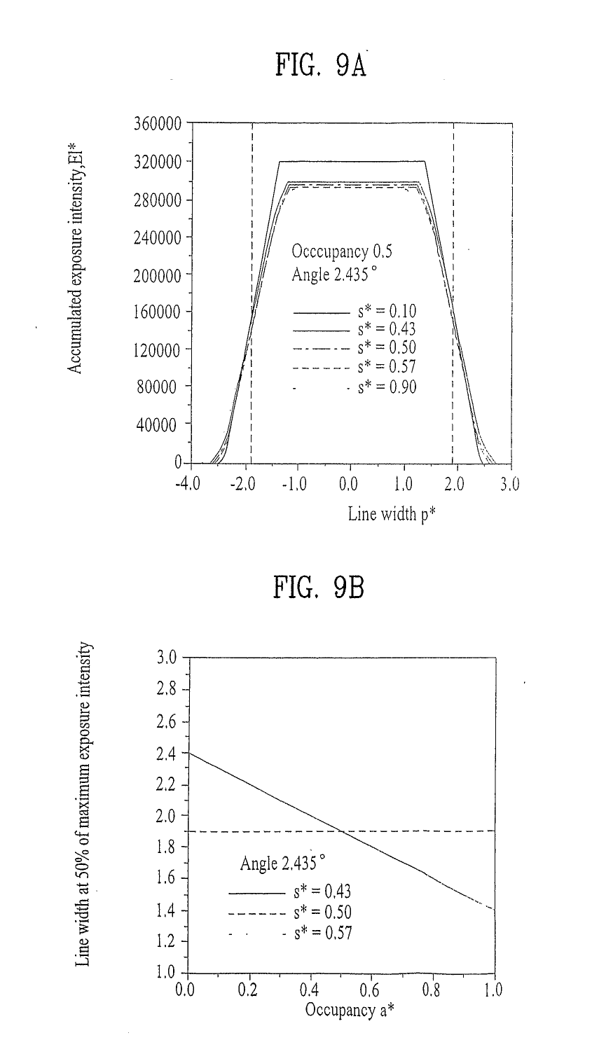

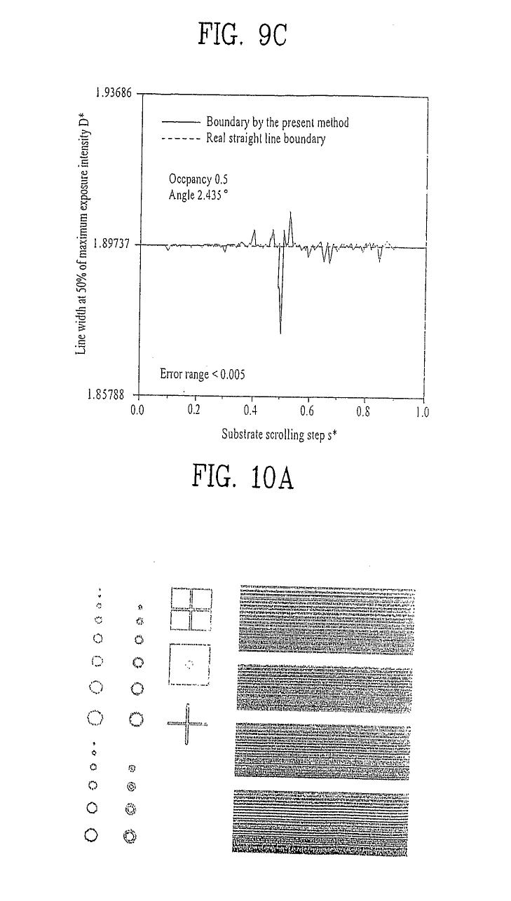

Meanwhile, the substrate scrolling step 0.50 shown in FIGS. 7A to 8B is a discrete scrolling step which is defined in the present invention as the dimensionless substrate scrolling step (s*) with the integer value of 1/s* . The step variation of the line width shown in FIG. 8A or FIG. 8B may induce a doubt that it is stable to avoid the discrete scrolling step, even though the line width and the line center are always conserved regardless of the scrolling step in the pattern generation method of the present invention. The variation is not significant but it must be closely examined, since the scrolling step more significantly affects both the quality of the lithography product and the manufacturing time/cost than the micromirror rotational angle and the energy accumulation due to beam scratch is also not considered in the simulations shown in FIG. 8A or FIG. 8B. So, to analyze the effect of the beam scratch while substrate scrolling and to prove the precision of pattern generation based on the unique reflection criterion upon occupancy, accumulated exposure intensity (EI*) simulations accounting the beam scratch while substrate scrolling are carried out on the same conditions assigned in the former simulations shown in FIG. 8A or FIG. 8B. FIG. 9A is a graph of accumulated exposure intensity EI* obtained as a function of a line width (p*) with an occupancy limit a_{c}* of 0.5, a mirror array rotational angle of 2.435° and a dimensionless substrate scrolling step s* of 0.1, 0.43, 0.5, 0.57 or 0.9.=FIG. 9B is a graph of a line width (P obtained at 50% of maximum exposure intensity as a function of an occupancy limit at 0.43, 0.5 or 0.57 of dimensionless substrate scrolling step (s*) with 2.435° of mirror array rotational angle. The simulation results shown in FIG. 9A and FIG. 9B confirm that, even if the beam scratch is accounted for, the conservation of the line width and the center is ensured through the pattern generation method according to the present invention.

Yet, despite that the beam scratch is taken into consideration, the step variation of the line width in the discrete scrolling step still appears in FIG. 9B. Since the substrate scrolling step considerably affects the lithography quality and the time and cost for the lithography process, it is necessary to accurately diagnose an error range. So, accumulated exposure intensity (EI*) simulations considering the beam scratch are carried out by assigning 101 dimensionless substrate scrolling steps (s*) between minimum 0.1 cos θ* and maximum 0.9 cos θ* at a mirror array rotational angle of 2.435° with an occupancy limit (a_{c}*) 0.5. FIG. 9C is a graph of a line width (p*) obtained at 50% of maximum exposure intensity as a function of a dimensionless substrate scrolling step (s*) between minimum 0.1 cos θ* and maximum 0.9 cos θ*, at a mirror array rotational angle of 2.435° with an occupancy limit (a_{c}*) of 0.5. The result of FIG. 9C indicates that an error between the line width (p*) obtained at 50% of the maximum accumulated exposure intensity and an actual line width increases in the vicinity of a discrete scrolling step. Yet, a resulting relative error in line widths is below 0.5% that is smaller than 1/10 of 5% of an acceptable tolerance suggested by FPD manufacturers. Hence, it is verified that the step variation of the line widths appearing in the discrete scrolling steps shown in FIG. 8A, FIG. 8B and FIG. 9B do not affect the lithography quality of the pattern generation method according to the present invention in the substrate scrolling steps between minimum 0.1 cos θ*FOV and maximum 0.9 cos θ*FOV, which can be considered as the whole range of the substrate scrolling step feasible in the actual maskless lithography.

The simulation results assure that the pattern generation is possible by the pattern generation method based on the unique micromirror reflection criterion upon occupancy on any conditions without limitations on the rotational angle of the micromirror array or the scrolling step of substrate. Hence, if the pattern generation method according to the present invention is used, optimal lithography conditions can be easily decided to obtain the optimal lithography result without limitation put on such a lithography parameter as a shape of light beam, a rotational angle of micromirror array, a scrolling step of substrate, a size of pattern, a structure or configuration of pattern and a PR removal rate.

In the step (103-3) of constructing the stream of binary patterns containing reflection information for the micromirrors, the binary reflection information contained in the micromirror dependent pattern extracted at each substrate scrolling step are stacked in the sequence of substrate scrolling, as shown in (f) of FIG. 3.

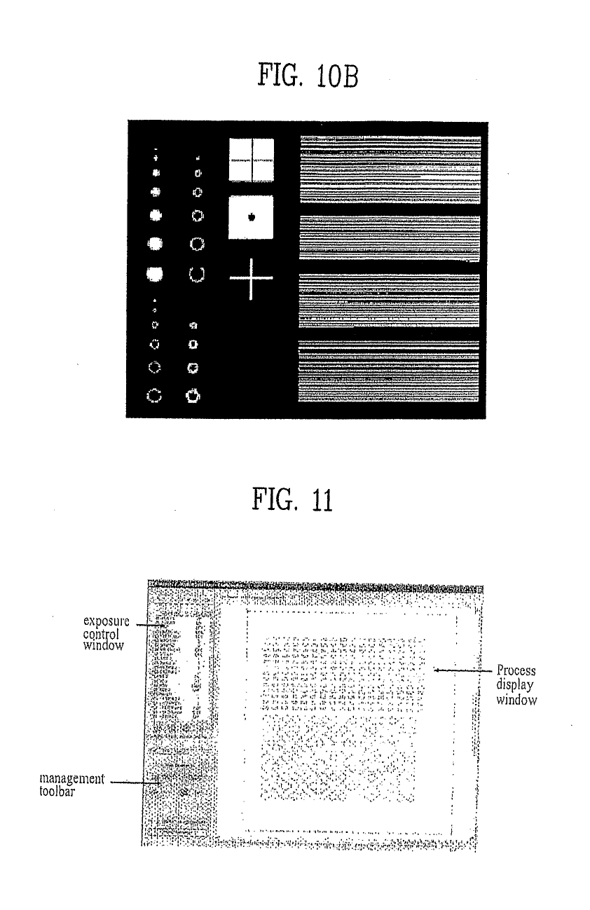

FIG. 10A shows a boundary extracted from a test pattern according to the present invention and FIG. 10B shows a result of exposure simulation by accumulating binary data according to the present invention.

As test pattern generation conditions, a reduced FOV of 10 μm, a rotational angle 5° of a micromirror array and a substrate scrolling step of 2 μm are assigned. An occupancy limit as the reflection criterion is fixed to 0.8 and a bit depth is held over 768. An exposure result generated by the exposure simulation shown in FIG. 10B is obtained from a total number of 3700 frames upon substrate scrolling steps used to irradiate the total area of the test pattern. And, the result of FIG. 10B proves the feasibility of high quality lithography through the present invention.

Finally, in the step 104 shown in FIG. 2, a stream of the binary pattern data is transmitted to the micromirror controller 41 at an optimal speed appropriate for performance of micromirrors. For the transmission of the stream of binary data to the micromirror controller, an electronic board by Texas Instruments Inc. with a data transit speed of 1,000 frames per second is selected to play the role as a deliverer.

The achievement of the objects of the real lithography by the occupancy based pattern generation method according to the present invention is implemented by a prototype lithographic pattern generation system. This system includes a lithographic pattern generation module explained with reference to FIG. 1, a signal interchange module (not shown in the drawings) responsible for real-time communications with hardware elements of a radiating control unit and a stage control unit, and a graphic user interface (GUI) enabling a lithographic pattern generation system operator to observe and manipulate system operations. A main window of the prototype lithographic pattern generation system is shown in FIG. 11. In the main window, an exposure control window, a management toolbar and a process display window are located at a left upper part, a left lower part and a right part, respectively. Referring to FIG. 11, process conditions selected to be inputted by a system operator are the origin of the reference/floating coordination system, angle of micromirror rotation, angle of substrate misalignment, two-directional micromirror resolution, exposure accuracy or scrolling distance upon scrolling step, occupancy limit, the selection of normal/flip/mirror conversion of the CAD data, etc. Thus, the lithographic pattern generation system is implemented to handle any possible user specified mandate and to solve such a system as a detailed adjustment for resolution enhancement, a substrate misalignment and the like.

Finally, for the validation of the pattern quality upon the lithographic pattern generation method according to the present invention, actual lithography is carried out to fabricate the pattern generated by the lithographic pattern generation method according to the present invention on actual wafers and display panels, with an enlarged 30 μm FOV, a micromirror array rotational angle of 2.9°, a substrate scrolling step of 9 μm and an occupancy limit as the reflection criterion of 0.5.

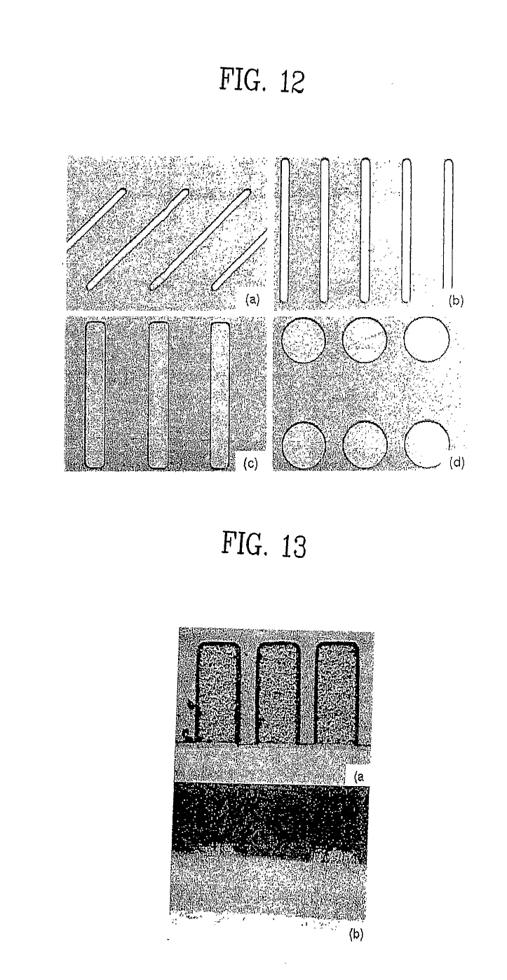

FIGS. 12(a) to 12(d) are electron microscope images of patterns on actual wafers, which are generated by the occupancy based pattern generation system according to the present invention, exposed, and developed. In input CAD data, the oblique line in FIG. 12(a) and the vertical line in FIG. 12(b) are 30 μm thick, the vertical line in FIG. 12(c) is 80 μm thick, and the circle in FIG. 12(d) has a 205 μm diameter. FIG. 13(a) and FIG. 13(b) are electron microscope images of patterns on FPD panels, which are generated by the occupancy based pattern generation system according to the present invention, exposed, and developed. The Dry Film Resistant (DFR) pattern shown in FIG. 13(a) has been cut in half to show a cross section and enlarged twice for FIG. 13(b). The boundaries of the patterns appear to be clear enough with extremely low roughness, proving the accuracy of the pattern generation method of the present invention. In particular, the fact that the error in the thickness of the 30 μm oblique line generated by 30 μm of FOV is less than 0.5% proves the precision of the pattern generation method of the present invention.

No unacceptable manifestation of discrepancies between the input from the CAD data and the output from the actual lithography is found, in spite of the presence of the possible errors due to the precision of the other component parts of the lithography equipment. The range of error is less than 5%, which is considered tolerable by FPD manufacturers. Hence, the lithographic pattern generation method according to the present invention is flexible, robust and precise.

Accordingly, an occupancy based pattern generation method for maskless lithography according to the present invention provides the following effects.

First of all, any kinds of complicated patterns can be handled using the unique occupancy of the present invention.

Secondly, since exposure is possible with uniform exposure intensity, exposure intensity adjustment is unnecessary.

Thirdly, since pattern generation is possible with any fixed light beam reflection angle, light beam reflection angle adjustment is unnecessary.

Fourthly, since pattern generation is possible with any fixed reflected light beam shape, shape manipulation of light beam reflecting from micromirrors is unnecessary.

Fifthly, pattern generation is possible in any kind of light beam.

Sixthly, the present invention is flexible, robust and precise.

Seventhly, no limitation is put on a rotational angle of micromirror array.

Eighthly, no limitation is put on a scrolling step of substrate.

Ninthly, it is able to perform exposure on a large-scale pattern such as FPD quickly and precisely.

Tenthly, lithography by the method according to the present invention is able to handle very many processes by software, thereby simplifying a structure of hardware.

Eleventhly, it is easy to set up optimal lithographic conditions such as a PR removal rate and the like.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, an occupancy based pattern generation method according to the present invention is applicable to all kinds of lithographic system using micromirrors. For instance, the present invention is applicable to a lithographic system (on which no limitation is put) that generates a pattern on a large-scale substrate (e.g., a flat panel display substrate produced in Korea, flat panel display (FPD)) using micromirrors.

1. An occupancy based pattern generation method for a maskless lithography system using micromirrors, comprising the steps of:
recognizing and generating a pattern upon the substrate through the extraction of the pattern boundary and the construction of the pattern region; and
recognizing and generating the pattern upon the micromirror through the confirmation of the micromirror dependent lithographic pattern region, the extraction of the micromirror dependent pattern based on the occupancy, and the construction of the stream of binary patterns containing binary reflection information for the micromirrors in accordance with the substrate scrolling.

2. The method of claim 1, further comprising the step of loading CAD data into a memory through parsing of the CAD data prior to extracting the boundary of the pattern.

3. The method of claim 1, further comprising the step of transmitting the accumulated binary pattern data to a micromirror controller.

4. The method of claim 1, wherein the extraction of the pattern boundary is carried out by reconstructing a geometric entity having an open loop into the one with a closed loop.

5. The method of claim 1, wherein the construction of the pattern region is carried out by an execution of set operations on polygons upon computational geometry.

6. The method of claim 1, wherein the confirmation of the micromirror dependent lithographic pattern region is carried out by projecting a pattern onto micromirrors in accordance with the micromirror rotation and the substrate misalignment.

7. The method of claim 1 wherein the extraction of the micromirror dependent pattern based on the occupancy is carried out by comparing the area occupied by the pattern per unit micromirror to the user specified occupancy limit to determine the binary reflection based upon the occupancy and by converting the result of binary reflection into binary data as the micromirror dependent pattern.

8. The method of claim 1, wherein the construction of the stream of binary patterns containing binary reflection information for the micromirrors is carried out by accumulating the binary reflection information contained in the micromirror dependent pattern at every substrate location in the sequence of substrate scrolling.

9. The method of claim 1, wherein the confirmation of the micromirror dependent lithographic pattern region is carried out by projecting the pattern onto micromirror array in a manner of rotating the pattern at an angle opposite to a rotational angle of the micromirror array and rotating the extracted part of the pattern back to an original position.

10. The method of claim 2, wherein the confirmation of the micromirror dependent lithographic pattern region is carried out by projecting the pattern onto micromirror array in a manner of rotating the pattern at an angle opposite to a rotational angle of the micromirror array and rotating the extracted part of the pattern back to an original position.

11. The method of claim 3, wherein the confirmation of the micromirror dependent lithographic pattern region is carried out by projecting the pattern onto micromirror array in a manner of rotating the pattern at an angle opposite to a rotational angle of the micromirror array and rotating the extracted part of the pattern back to an original position.

12. The method of claim 4, wherein the confirmation of the micromirror dependent lithographic pattern region is carried out by projecting the pattern onto micromirror array in a manner of rotating the pattern at an angle opposite to a rotational angle of the micromirror array and rotating the extracted part of the pattern back to an original position.

13. The method of claim 5, wherein the confirmation of the micromirror dependent lithographic pattern region is carried out by projecting the pattern onto micromirror array in a manner of rotating the pattern at an angle opposite to a rotational angle of the micromirror array and rotating the extracted part of the pattern back to an original position.
